(19) United States
(12) Patent Application Publication
(10) Pub. No.: US 2009/0096880 A1
(43) Pub. Date: Apr. 16, 2009

(54) INFORMATION PROCESSING APPARATUS, STORING METHOD, AND COMPUTER READABLE RECORDING MEDIUM

(75) Inventor: Kei Tanaka, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/146,117

(22) Filed: Jun. 25, 2008

(30) Foreign Application Priority Data
Oct. 16, 2007 (JP) 2007-269076

(51) Int. Cl. H04N 5/232

(52) U.S. Cl. 348/211.14

(57) ABSTRACT

An information processing apparatus is connected to an image capture device, and a plurality of external terminals that inputs annotation information to an image captured by the image capture device. The information processing apparatus includes an acquiring portion that acquires input information from the plurality of external terminals, a storing portion that stores a synthesis image in which the captured image and the annotation information are synthesized, and a controlling portion that causes the storing portion to store the synthesis image when the acquisition of the input information by the acquiring portion is not executed for a predetermined time period.

### CROSS-REFERENCE TO RELATED APPLICATION

This application is based on and claims priority under 35 USC 119 from Japanese Patent Application No. 2007-269076 filed Oct. 16, 2007.

### BACKGROUND

1. Technical Field

The present invention relates to an information processing apparatus, a storing method, and a computer readable recording medium, and in particular to an information processing apparatus which is connected to an image capture device capturing an object, and plural external terminals inputting annotation information to an image captured by the image capture device, a storing method storing an image, and a computer readable recording medium causing a computer to execute a process.

2. Related Art

There have been known remote indication systems, each of the remote indication systems including a server (e.g. a computer) connected to a video camera and a projector, and a remote client (e.g. a computer) connected to the server via a network.

### SUMMARY

According to an aspect of the invention, there is provided an information processing apparatus that is connected to an image capture device, and a plurality of external terminals that inputs annotation information to an image captured by the image capture device, including: an acquiring portion that acquires input information from the plurality of external terminals; a storing portion that stores a synthesis image in which the captured image and the annotation information are synthesized; and a controlling portion that causes the storing portion to store the synthesis image when the acquisition of the input information by the acquiring portion is not executed for a predetermined time period.

### BRIEF DESCRIPTION OF THE DRAWINGS

Exemplary embodiments of the present invention will be described in detail based on the following figures, wherein:

FIG. 1 is a schematic diagram showing the structure of a remote indication system in accordance with an exemplary embodiment of the present invention;

FIG. 2 is a block diagram showing the functional structures of a PC 1, a PC 2, and a PC 2′;

FIG. 3 is a block diagram showing the functional structure of a storing timing determination unit in FIG. 2;

FIG. 4 is a flowchart showing a process executed by the storing timing determination unit; and

FIG. 5 is a schematic diagram showing the structure of the remote indication system in accordance with a variation of the exemplary embodiment.

### DETAILED DESCRIPTION

A description will now be given, with reference to the accompanying drawings, of an exemplary embodiment of the present invention.

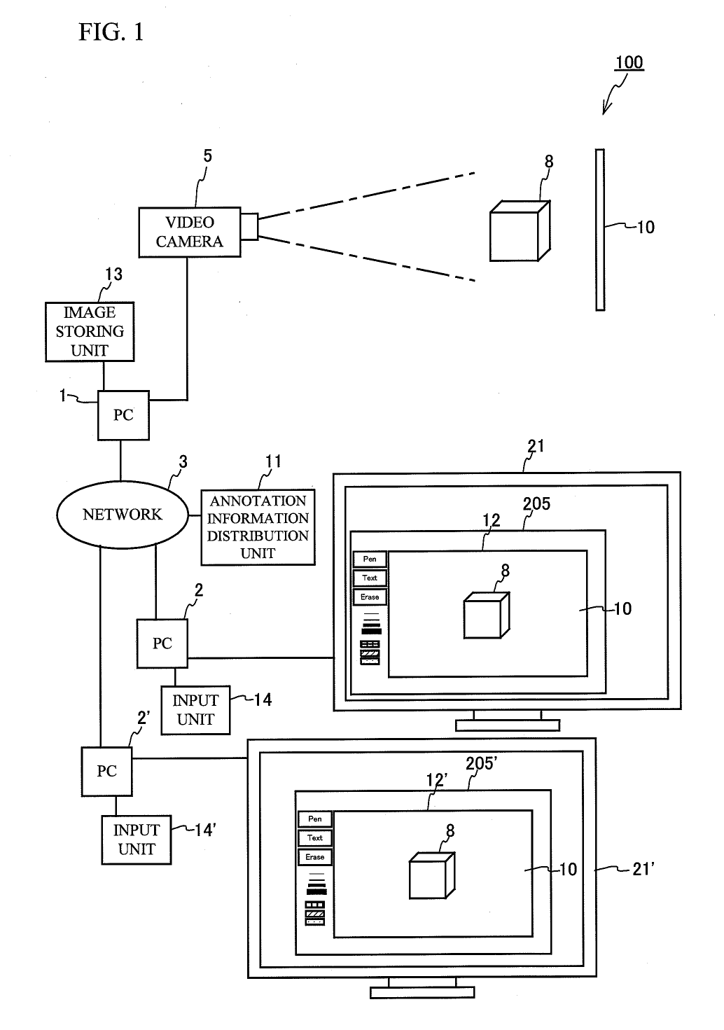

FIG. 1 schematically shows the structure of a remote indication system 100 including an information processing apparatus in accordance with an exemplary embodiment of the present invention. The remote indication system 100 includes a personal computer (PC) 1 (the information processing apparatus) functioning as a server, and PCs 2 and 2′ (external terminals) functioning as clients. The PC 1 and the PCs 2 and 2′ are connected to each other via a network 3. An annotation information distribution unit 11 is connected to the network 3.

A video camera 5 (an image capture device) is connected to the PC 1. The video camera 5 captures a reflected image of a screen 10 including an object 8, and outputs a captured image to the PC 1.

The PC 1 outputs the image captured by the camera 5 to the PC 2 and the PC 2′ via the network 3. The PC 2 is connected to a display 21 (a display portion), and an input unit 14 which is composed of a mouse or the like. The display 21 displays the captured image (specifically, the captured image of the screen 10 including the object 8 in FIG. 1) on a display area 12 in a window 205. A display 21′ and an input unit 14′ are connected to the PC 2′, and the display 21′ displays the captured image on a display area 12′ in a window 205′. The PC 2 (or 2′) may be a personal computer that is integrated with the display 21 (or 21′).

A group of buttons such as a pen button, a text button, and an erase button, and icons defined by lines and colors are displayed on the window 205 (or 205′).

For example, when the pen button is selected by a mouse pointer which moves in the window 205 (or 205′) in response to movement of the input unit 14 (or 14′) (e.g. the mouse) operated by the user of the PC 2 (or 2′), and then a figure or the like on the object 8 in the display area 12 is drawn by the movement of the mouse pointer, the information about the figure (specifically, the coordinates (x, y) representing the figure in the display area 12) is output from the PC 2 to the annotation information distribution unit 11 connected to the network 3. Here, the figure drawn on the object includes an image of any types such as a line, a character, a symbol, a figure, a color, and a font.

The annotation information distribution unit 11 outputs the information about the figure to the PC 1, the PC 2, and the PC 2′. The PC 1 stores the information about the figure input from the annotation information distribution unit 11. Further, the PC 1 synthesizes the information about the figure and the image captured by the video camera 5 in predetermined timing, and stores the synthesized image in an image storing unit 13. The PC 2 (or 2′) synthesizes the information about the figure input from the annotation information distribution unit 11 and the image which is captured by the video camera 5 and transmitted from the PC 1, and displays the synthesized image on the display area 12 in the window 205 (or 205′).

The PC 2 (or 2′) outputs control commands to the PC 1, so as to control operations of the video camera 5 (e.g. the capture angles, the brightness and the like of images captured by the camera 5).

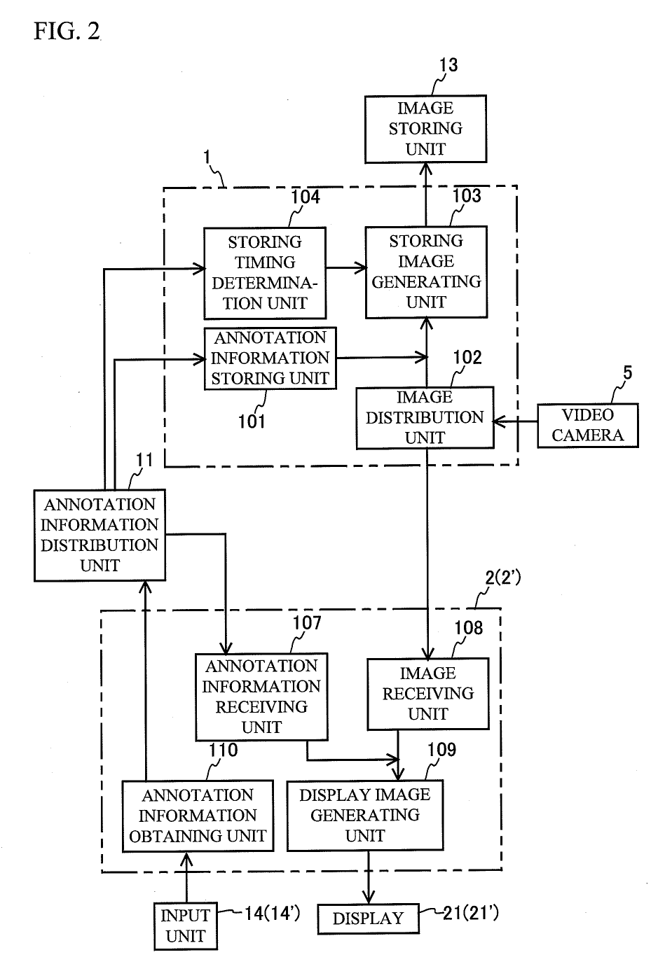

A block diagram in FIG. 2 shows the functional structures of the PC 1 and the PC 2 (or 2′). As shown in FIG. 2, the PC 1 includes an annotation information storing unit 101, an image distribution unit 102, a storing image generating unit 103, a storing timing determination unit 104 as a acquiring potion and a controlling portion in accordance with the exemplary embodiment of the present invention.

The annotation information storing unit 101 receives the annotation information transmitted from the annotation information distribution unit 11 via the network 3 (see FIG. 1) and stores the annotation information. The image distribution unit 102 outputs the image captured by the video camera 5 to the storing image generating unit 103 in the PC 1, and distribute the captured image to the PC 2 and the PC 2′. The storing image generating unit 103 synthesizes the image output from the image distribution unit 102 and the annotation information output from the annotation information storing unit 101 by an image process, generates a synthetic image, and stores the synthetic image in the image storing unit 13 connected to the PC 1. That is, a storing portion in accordance with the exemplary embodiment of the present invention is composed of the storing image generating unit 103 and the image storing unit 13. The storing timing determination unit 104 decides generating and storing timing of the synthetic image by the storing image generating unit 103, based on the annotation information transmitted from the annotation information storing unit 101, and instructs the storing image generating unit 103 to generate the synthetic image in each decided timing. A decision method of the timing by the storing timing determination unit 104 will be described in detail hereinafter.

The PC 2 (or 2′) includes an annotation information receiving unit 107, an image receiving unit 108, a display image generating unit 109, and an annotation information obtaining unit 110.

The annotation information receiving unit 107 receives the annotation information transmitted from the annotation information distribution unit 11 via the network 3 (see FIG. 1). The image receiving unit 108 receives the image (i.e., the image captured by the video camera 5) distributed from the image distribution unit 102 in the PC 1 via the network 3. The display image generating unit 109 synthesizes the image received from the image receiving unit 108 and the annotation information received from the annotation information receiving unit 107 by an image process, generates a synthetic image, and displays a synthetic image on the window 205 (or 205′) (i.e., the display area 12 (or 12′)) in the display 21 (or 21′). The annotation information obtaining unit 110 transmits the annotation information input from a user to the annotation information distribution unit 11.

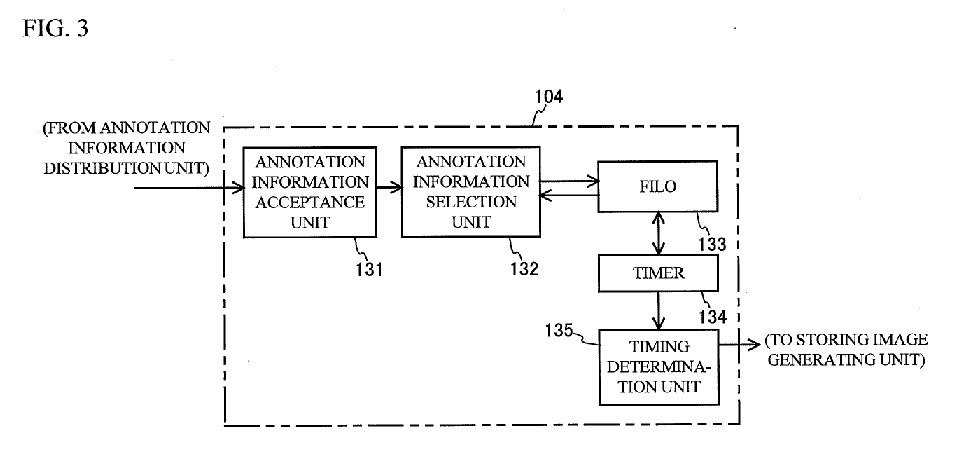

A block diagram in FIG. 3 shows the functional structure of the storing timing determination unit 104 described above. As shown in FIG. 3, the storing timing determination unit 104 includes an annotation information acceptance unit 131, an annotation information selection unit 132, a FILO (First In Last Out) type memory 133 (hereinafter merely referred to as “FILO”), a timer 134, and a timing determination unit 135.

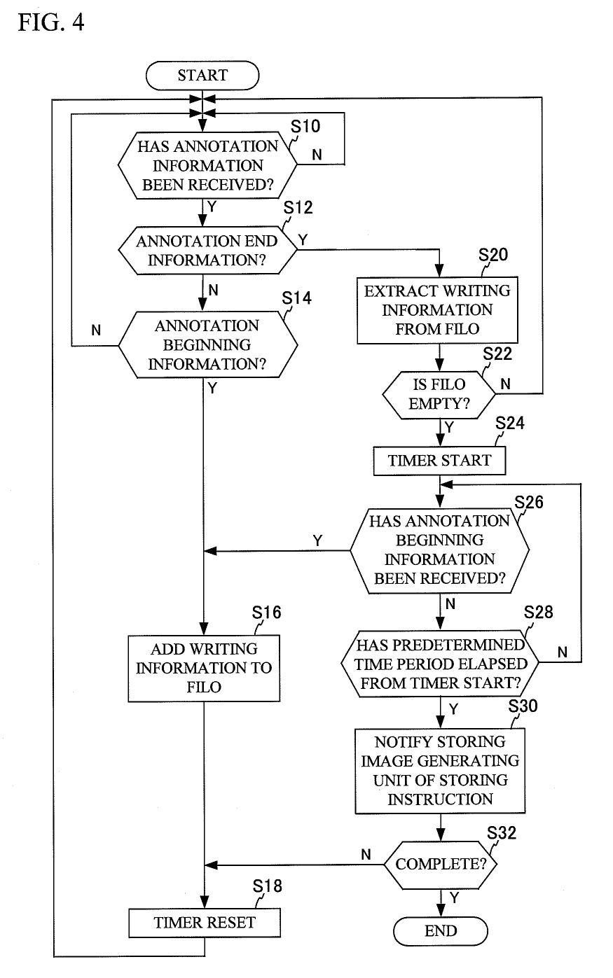

Here, the operation of each unit which composes the storing timing determination unit 104 will be described with reference to a flowchart shown in FIG. 4.

In step S10, the annotation information acceptance unit 131 (see FIG. 3) first determines whether the annotation information has been received. The annotation information acceptance unit 131 waits until the answer to the determination of step S10 is “YES”.

Here, the annotation information includes “annotation beginning information” which is information showing the beginning of the annotation, “annotation end information” which is information showing the end of the annotation, “other information” which is information showing the continuance of the annotation. For example, when the input unit 14 (or 14′) of the PC 2 (or 2′) is a mouse, the annotation beginning information represents “the depression of a left button of the mouse (in a state where a mouse pointer is included in the display area)”, and the annotation end information represents “the release of the left button of the mouse”. Further, when the input unit 14 (or 14′) is a tablet or a touch panel, the annotation beginning information represents “pushing down the pen”, and the annotation end information represents “lifting the pen”. When a device recognizing a position of the pen from an image is used, a state where the pen appears in the image may be assumed to be the annotation beginning information, and a state where the pen disappears from the image may be assumed to be the annotation end information.

Then, the annotation information acceptance unit 131 receives the annotation information, and when the answer to the determination of step S10 is “YES”, the procedure proceeds to step S12. In step S12, the annotation information selection unit 132 (see FIG. 3) determines whether the received annotation information has been the “annotation end information”. When the answer to the determination of step S12 is “NO”, the procedure proceeds to step S14. In step S14, the annotation information selection unit 132 determines whether the received annotation information has been the “annotation beginning information”. When the answer to the determination of step S14 is “NO” (i.e., the received annotation information has been the “other information”, the procedure returns to step S10. Then, until the annotation information acceptance unit 131 receives the annotation end information or the annotation beginning information, the procedures of steps S10 to S14 are repeated.

Then, the annotation information acceptance unit 131 receives the annotation beginning information, and when the answer to the determination of step S14 is “YES”, the procedure proceeds to step S16. In step S16, the annotation information selection unit 132 adds writing information to the FILO 133. In this case, the writing information means information which shows that the writing has done, and includes information which shows whether the annotation is written by any one of the PC 2 and PC 2′ and shows time when the annotation is written, for example. Further, this is not limitative, but the writing information may be merely data which shows that the writing has done.

When the procedure of step S16 is finished, the procedure proceeds to step S18. In step S18, the timer 134 is reset, and the procedure returns to step S10. In the exemplary embodiment of the present invention, the annotation beginning information are sequentially input from the PC 2 and the PC 2′, respectively, the procedures of steps S10, S12, S14, S16, and S18 are repeated twice, and two pieces of the writing information are stored in the FILO 133. Hereafter, a description will be given on the assumption of this.

When the answers to the determination of steps S10 and S12 are “YES” (i.e., when the annotation information has been the annotation end information), the procedure proceeds to step S20. In step S20, the annotation information selection unit 132 extracts the writing information from the FILO 133 by a FILO (First In Last Out) process.

In next step S22, the annotation information selection unit 132 determines whether the FILO 133 is empty. Now, one piece of the writing information remains yet, and therefore the answer to the determination of step S22 is “NO”. The procedure returns to step S10. When the annotation end information is input again, the answers to the determination of steps S10 and S12 are “YES”, and the procedure proceeds to step S20. In step S20, the annotation information selection unit 132 extracts the writing information from the FILO 133, and then the procedure proceeds to step S22. In this case, since the FILO 133 is empty, the answer to the determination of step S22 is “YES”, and the procedure proceeds to step S24. In step S24, the timer 134 starts measurement of time.

Then, a process in which the annotation information acceptance unit 131 determines in step S26 whether the annotation beginning information has been received, and a process in which the timing determination unit 135 (see FIG. 3) determines in step S28 whether a predetermined time period (e.g. 2 or 3 seconds) has elapsed from the start of measurement of time are alternately repeated, until the answer to any one of the determination of steps S26 and S28 is “YES”.

When the answer to the determination of step S26 is “YES” during the above-mentioned repetition, the procedure proceeds to step S16. On the other hand, when the answer to the determination of step S28 is “YES” (i.e., the annotation is not written for the predetermined time period since the FILO 133 is empty), the procedure proceeds to step S30. In step S30, the timing determination unit 135 notifies the storing image generating unit 103 (see FIG. 2) of a storing instruction. The storing image generating unit 103 synthesizes, based on the storing instruction, the image input from the image distribution unit 102 and the information input from the annotation information storing unit 101 by the image process to generate the synthetic image.

Then, the procedure proceeds to step S32. In step S32, the annotation information selection unit 132 determines whether the PC 1, the PC 2 or the PC 2′ has executed a complete process. When the answer to the determination of step S32 is “NO”, the procedure proceeds to step S18. In step S18, the timer 134 is reset, and then the procedure returns to step S10. The above-mentioned procedures and determination are repeated. When the answer to the determination of step S32 is “YES”, all procedures in FIG. 4 are finished. As described above, for convenience of explanation, it is determined in step S32 after step S30 whether the PC 1, the PC 2 or the PC 2′ has executed the complete process, but the complete process may be executed as an interrupt process.

As described above, the user holds a meeting for which the remote indication system 100 is used, and then can produce minutes of the meeting with the synthetic image stored in the image storing unit 13.

As described in detail above, according to the exemplary embodiment, when the acquisition of input information from plural external terminals (i.e., the PC 2 and the PC2′) is not executed for the predetermined time period, the storing timing determination unit 104 causes the storing image generating unit 103 to store the synthetic image (i.e., the image in which the captured image and the annotation image are synthesized) in the image storing unit 13. Thus, even when plural external terminals (and plural users) exist, it is possible to store the synthetic image in appropriate timing (e.g. the timing of the break between arguments in the meeting for which the plural external terminals (i.e., the PC 2 and the PC2′) are used). Further, existence or nonexistence of change in the synthetic image can be determined without the image process or the like, and it is therefore possible to inhibit the apparatus and processes from complicating.

According to the exemplary embodiment, when pieces of annotation end information having the same number as pieces of acquired annotation beginning information are acquired with the FILO 133 and the timer 134, and then the predetermined time period has elapsed, the storing timing determination unit 104 causes the storing image generating unit 103 to store the synthetic image in the image storing unit 13. It is therefore possible to store the synthetic image in appropriate timing with a simple arrangement.

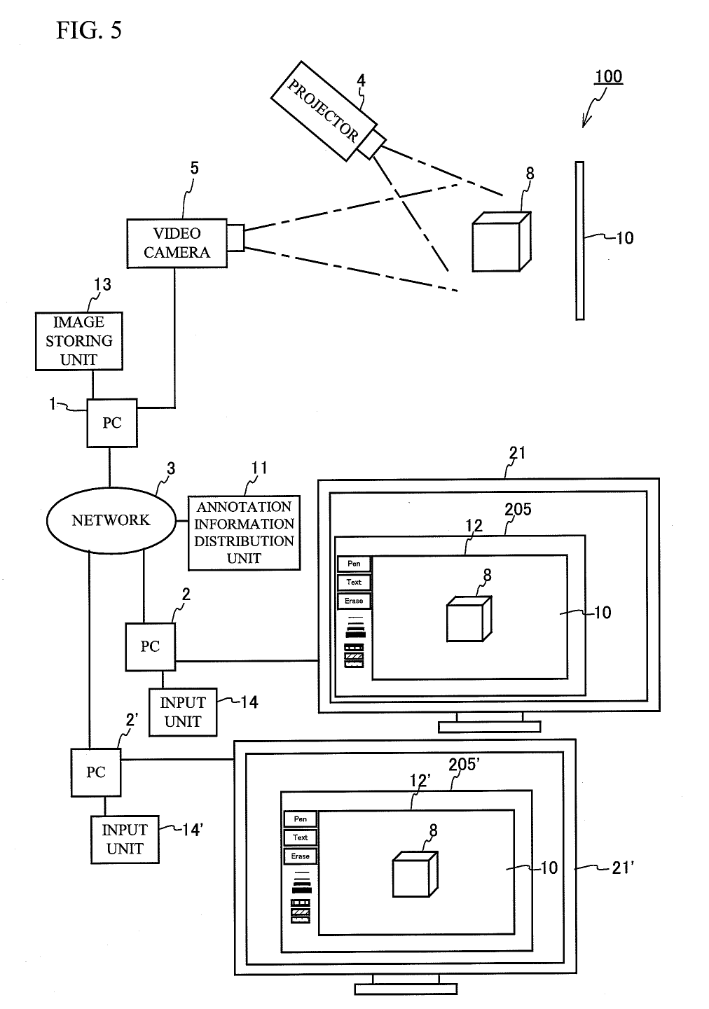

In the above-mentioned exemplary embodiment, although the synthesis of the captured image and the annotation image is executed by the image process, the exemplary embodiment is not limited to this. For example, as shown in FIG. 5, a projector 4 is connected to the PC 1, the annotation image is projected onto the object 8 and the screen 10 via the projector 4, and the video camera 5 captures the object 8 and the screen 10, so that the captured image and the annotation image may be synthesized. Of course, the projection of a figure by the projector 4, and the synthesis of the captured image and the annotation image by the image process may be used at the same time.

In the above-mentioned exemplary embodiment, although the PC 1 does not include a display, an input unit and the like, the exemplary embodiment is not limited to this. For example, the PC 1 may include the display displaying the captured image, and the input unit composed of a mouse, a keyboard, and the like. In this case, in addition to the above arrangements, the PC 1 may further include an annotation information obtaining unit 110 in common with the PC 2.

In the above-mentioned exemplary embodiment, although the annotation information distribution unit 11 is disposed on the network 3, the exemplary embodiment is not limited to this. For example, the PC 1 may realize the functions of the annotation information distribution unit 11. Further, the functions of the annotation information distribution unit 11 may be realized by not only the PC 1 but the PC 2 or the PC 2′.

Although the remote indication system 100 in accordance with the above-mentioned exemplary embodiment includes two clients (i.e., the PCs 2 and 2′), the exemplary embodiment is not limited to this, and the remote indication system 100 may include three or more clients.

Alternatively, a recording medium having the software program for realizing the functions of the PC 1, the PC 2, and the PC 2′ recorded thereon may be provided to each PC, and the CPU of each PC may read and execute the program recorded on the recording medium. In this manner, the same effects as those of the above described exemplary embodiment can also be achieved. The recording medium for supplying the program may be a CD-ROM, a DVD, a SD card, or the like.

Also, the CPU of each PC may execute the software program for realizing the functions of each PC. In this manner, the same effects as those of the above-described exemplary embodiment can also be achieved.

Although the remote indication system 100 in accordance with the above-mentioned exemplary embodiment uses the FILO as a memory, the exemplary embodiment is not limited to this, and the remote indication system 100 may use a FIFO (First In First Out) type memory. In this case, information from the memory is acquired in such a manner as the FIFO (First In First Out).

It should be understood that the present invention is not limited to the above-described exemplary embodiment, and various modifications may be made to them without departing from the scope of the invention.

What is claimed is:

1. An information processing apparatus that is connected to an image capture device, and a plurality of external terminals that input annotation information to an image captured by the image capture device, comprising:
an acquiring portion that acquires input information from the plurality of external terminals;
a storing portion that stores a synthesis image in which the captured image and the annotation information are synthesized; and
a controlling portion that causes the storing portion to store the synthesis image when the acquisition of the input information by the acquiring portion is not executed for a predetermined time period.

2. The information processing apparatus according to claim 1, wherein the acquiring portion acquires pieces of input beginning information with respect to the annotation information from the plurality of external terminals, respectively, and pieces of input end information with respect to the annotation information from the plurality of external terminals, respectively,
when the acquiring portion acquires the pieces of input end information having the same number as the pieces of input beginning information acquired by the acquiring portion, and then the predetermined time period has elapsed, the controlling portion causes the storing portion to store the synthesis image.

3. The information processing apparatus according to claim 2, wherein the acquiring portion includes a first-in-last-out (FILO) type memory,
when the acquiring portion acquires the input beginning information from any one of the plurality of external terminals, writing information is stored in the FILO type memory, and when the acquiring portion acquires the input end information from any one of the plurality of external terminals, the writing information is extracted from the FILO type memory by a FILO method, and
when the predetermined time period has elapsed from a state where the FILO type memory stores no writing information, the controlling portion causes the storing portion to store the synthesis image.

4. The information processing apparatus according to claim 1, wherein the storing portion synthesizes the captured image and the annotation information by an image process, and stores the synthesis image.

5. The information processing apparatus according to claim 1, further comprising a projecting device that projects the annotation information onto a capture area, wherein the storing portion stores an image in the capture area onto which the annotation information is projected, the capture area being directly captured by the image capture device.

6. A storing method storing an image executed by an apparatus inputting annotation information to a captured image in which an object is captured, via a plurality of external terminals, comprising:
acquiring input information with respect to the annotation information via the plurality of external terminals; and
storing an synthesis image in which the captured image and the annotation information are synthesized when the acquisition of the input information is not executed for a predetermined time period.

7. A computer readable recording medium causing a computer to execute a process, the computer including a memory, and being connected to an image capture device, and a plurality of external terminals that input annotation information to an image captured by the image capture device, the process comprising:
acquiring input information from the plurality of external terminals;
storing into the memory a synthesis image in which the captured image and the annotation information are synthesized; and
causing the memory to store the synthesis image when the acquisition of the input information is not executed for a predetermined time period.
